(19) United States
(12) Patent Application Publication
(10) Pub. No.: US 2016/0321131 A1
(43) Pub. Date: Nov. 3, 2016

(54) METHOD FOR DIAGNOSING INFORMATION PROCESSING DEVICE, RECORDING MEDIUM, AND INFORMATION PROCESSING DEVICE

(71) Applicant: FUJITSU LIMITED, Kawasaki-shi (JP)

(72) Inventors: Toshihiro MIYAMOTO, Machida (JP); Tatsuya SHIMURA, Kawasaki (JP); Nobuyuki KOIKE, Kawasaki (JP); Hiromi KOIZUMI, Kawasaki (JP)

(73) Assignee: FUJITSU LIMITED, Kawasaki-shi (JP)

(21) Appl. No.: 15/210,837

(22) Filed: Jul. 14, 2016

Related U.S. Application Data
(63) Continuation of application No. PCT/JP2014/051869, filed on Jan. 28, 2014.

(51) Int. Cl. G06F 11/07

(52) U.S. Cl. CPC G06F 11/0778; G06F 11/0721; G06F 11/0751; G06F 11/079

(57) ABSTRACT

A method for diagnosing an information processing device includes issuing a first interrupt that is an interrupt specific to a CPU, transferring a control from processing of the first interrupt to a second interrupt that starts a dump collection function, and starting a dump collection on the basis of the second interrupt.

### CROSS-REFERENCE TO RELATED APPLICATION

This application is a continuation application of International Application PCT/JP2014/051869 filed on Jan. 28, 2014 and designated the U.S., the entire contents of which are incorporated herein by reference.

### FIELD

The embodiments discussed herein are related to a method for diagnosing an information processing device, a recording medium, and the information processing device.

### BACKGROUND

When a failure occurs while a computer is operating, a dump collection is performed to analyze an occurrence factor of the failure. A collected dump is data used to analyze a failure that has occurred, and includes, for example, a content of a memory and a content of a register of a central processing unit (CPU).

As a related technology, a technology has been proposed that issues, according to a first interrupt, a second interrupt for executing a program arranged at an address indicated by a reset vector so as to perform reset processing. Further, a technology has been proposed in which, when a system failure in a guest operating system (OS) is detected, a management OS issues, through a software interface, an external interrupt for a virtual CPU that operates the guest OS (see, for example, Patent Document 1 and Patent Document 2).
Patent Document 1: Japanese Laid-open Patent Publication No. 2011-232986
Patent Document 2: Japanese Laid-open Patent Publication No. 2011-243012

### SUMMARY

According to an aspect of the embodiments, a method for diagnosing an information processing device includes issuing a first interrupt that is an interrupt specific to a CPU, transferring a control from processing of the first interrupt to a second interrupt that starts a dump collection function, and starting a dump collection on the basis of the second interrupt.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a configuration of a computer according to an embodiment;

FIG. 2 illustrates and example of a configuration of a keyboard controller according to the embodiment;

FIG. 3A illustrates examples of an input/output pin of a second general-purpose IO port;

FIG. 3B illustrates examples of a waveform of the pin;

FIG. 4 is a block diagram that illustrates an example of a function of a firmware of a keyboard controller;

FIG. 5 illustrates examples of an SMM handler and an SMI stack of a memory;

FIG. 6 is a flowchart that illustrates an example of a flow of processing of the embodiment;

FIG. 7 illustrates an example of a key manipulation until a second flag is turned on;

FIG. 8 illustrates an example of a level of an interrupt managed by an OS;

FIG. 9 is a flowchart that illustrates an example of NMI redirection processing of FIG. 5;

FIG. 10 is a flowchart that illustrates an example of NMI processing of FIG. 5; and

FIG. 11 illustrates an example of a state in which a memory and a register transition.

### DESCRIPTION OF EMBODIMENTS

A dump collection is started on the basis of a trigger that instructs a dump collection to be performed. There is a possibility that an OS that operates in a computer will not function normally when a failure occurs in the computer. There is a possibility that the OS will not recognize the trigger for starting a dump collection when the OS does not operate normally. The dump collection will not be started when the OS does not recognize the trigger.

<Information processing Device>

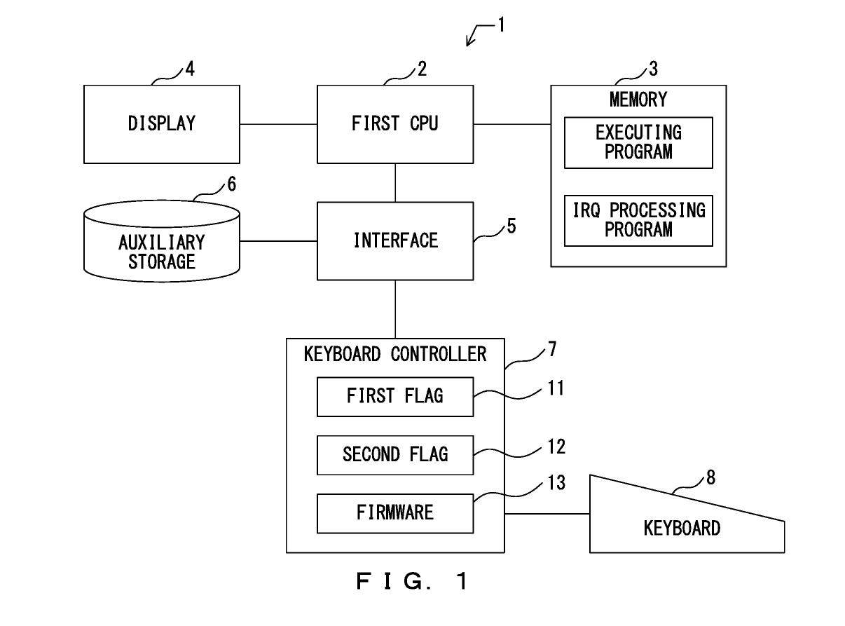

Embodiments will now be described with reference to the drawings. FIG. 1 illustrates a computer 1. The computer 1 is an example of an information processing device. As the computer 1, any information processing device such as a personal computer or a workstation may be used. Further, the computer 1 may be not only a desktop computer but also a portable computer.

The computer 1 illustrated in FIG. 1 as an example includes a first CPU 2, a memory 3, a display 4, an interface 5, an auxiliary storage 6, a keyboard controller 7, and a keyboard 8. The computer 1 is not limited to the configuration of FIG. 1.

The first CPU 2 is a processor that performs prescribed processing. The first CPU 2 may be simply referred to as a CPU. The memory 3 is a device that stores therein information. The first CPU 2 can read information from the memory 3 or write information into the memory 3. The first CPU 2 can read a program stored in the memory 3 so as to execute the program.

As illustrated in FIG. 1, the memory 3 stores therein an executing program and an interrupt request (IRQ) processing program. The executing program is a program that is being executed by the first CPU 2. The IRQ processing program is a program executed by the first CPU 2. The IRQ processing program is a program that performs interrupt processing. The IRQ processing program is also referred to as an interrupt handler.

The display 4 is a display device that displays prescribed information on the basis of an instruction issued by the first CPU 2. The interface 5 is connected to the first CPU 2, the auxiliary storage 6, and the keyboard controller 7. The first CPU 2 controls the auxiliary storage 6 or the keyboard controller 7 through the interface 5. As an example, a platform controller hub (PCH) that establishes a bridging connection between the first CPU 2 and peripheral equipment may be used as the interface 5.

The auxiliary storage 6 is a device that stores therein information. In the embodiment, it is assumed that the auxiliary storage 6 is a hard disk, but the auxiliary storage 6 is not limited to being a hard disk. In the embodiment, it is assumed that the auxiliary storage 6 stores therein an OS. The OS stored in the auxiliary storage 6 is read into the memory 3 and executed by the first CPU 2.

The keyboard controller 7 controls the keyboard 8. The keyboard 8 is an input device that includes a plurality of keys. The keyboard controller 7 includes a first flag 11, a second flag 12, and a firmware 13. The first flag 11 and the second flag 12 are flags that indicate “ON” or “OFF”. The firmware 13 is software that is stored in a storage of the keyboard controller 7.

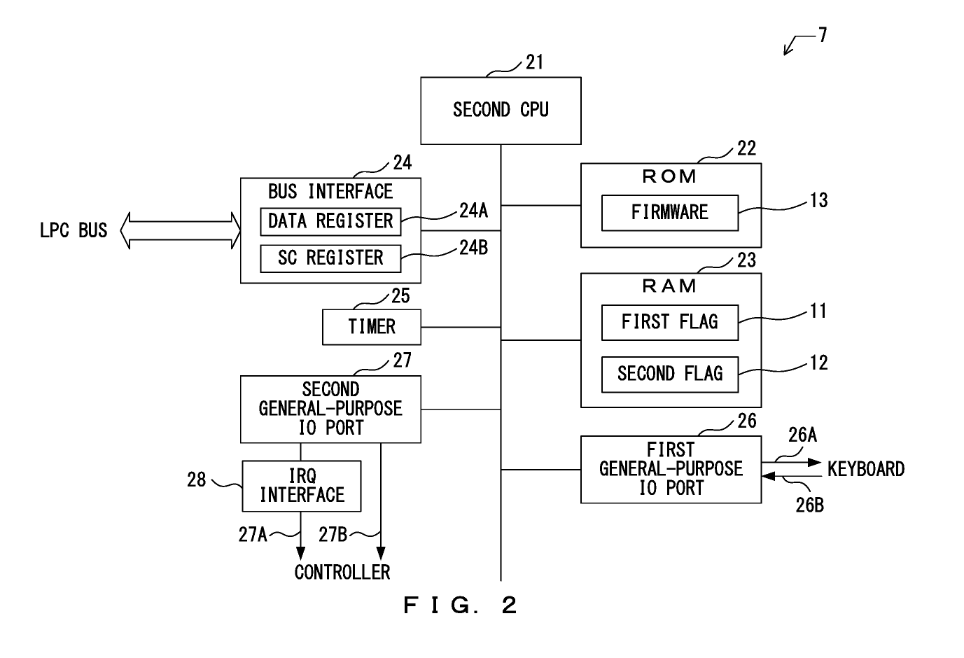

Next, the keyboard controller 7 that is illustrated in FIG. 2 as an example is described. The keyboard controller 7 includes a second CPU 21, a read only memory (ROM) 22, a random access memory (RAM) 23, a bus interface 24, a timer 25, a first general-purpose IO port 26, a second general-purpose IO port 27, and an IRQ interface 28.

The second CPU 21 is a processor that performs prescribed processing. The second CPU 21 is different from the first CPU 2 in that it is included in the keyboard controller 7. The keyboard controller 7 basically includes one second CPU 21 (one chip CPU).

The ROM 22 stores therein the firmware 13. The firmware 13 stored in the ROM 22 is executed by the second CPU. The ROM 22 may store therein information other than firmware. The storage in which the firmware 13 is stored is not limited to the ROM 22.

The RAM 23 stores therein the first flag 11 and the second flag 12. The RAM 23 may store therein information other than the first flag 11 and the second flag 12. The second CPU 21 can read information stored in the RAM 23 or write information into the RAM 23.

The bus interface 24 is an interface that is connected to a low pin count (LPC) bus. The LPC bus is a bus that connects a low bandwidth device to the second CPU 21. The bus interface 24 includes a data register 24A and a status command register 24B. In FIG. 2, the status command register is represented by “SC REGISTER”.

The timer 25 is a device that measures time. The timer 25 of FIG. 2 is a hardware timer. The function of the timer 25 is not limited to the hardware timer. For example, the second CPU 21 may measure time.

The first general-purpose IO port 26 obtains manipulation information with respect to the keyboard 8. The first general-purpose IO port 26 performs scanning (26A) with respect to a keyboard matrix of the keyboard 8 so as to obtain the manipulation information with respect to the keyboard 8. The first general-purpose IO port 26 obtains the manipulation information (26B) so as to recognize which of the keys in the keyboard 8 has been depressed.

The second general-purpose IO port 27 is connected to the IRQ interface 28. The IRQ interface 28 outputs an interrupt signal (an IRQ signal). An IRQ signal 27A output by the IRQ interface 28 is a serial signal, and the IRQ signal 27A is input into the first CPU 2 through the interface 5.

The second general-purpose IO port 27 outputs an SMI signal 27B indicating that a system management interrupt (SMI) has been issued. The SMI is an instruction specific to the first CPU 2 and is an example of a first interrupt. The SMI is a hardware-level interrupt and is an interrupt that is not managed by the OS.

In other words, the SMI is also an interrupt that is a function of the first CPU 2. The first CPU 2 can recognize an issuance of the SMI regardless of the state of the OS because the SMI is not managed by the OS.

The second general-purpose IO port 27 can output two types of interrupt signals, the IRQ signal 27A and the SMI signal 27B. Further, when the interface 5 (for example, PCH) has a redirection table, the second general-purpose IO port 27 can input both the IRQ signal 27A and the SMI signal 27B that are output from the keyboard controller 7 if the redirection table is set.

In FIG. 2, the first general-purpose IO port 26 and the second general-purpose IO port 27 are illustrated separately, but the first general-purpose IO port 26 and the second general-purpose IO port 27 may be one general-purpose IO port.

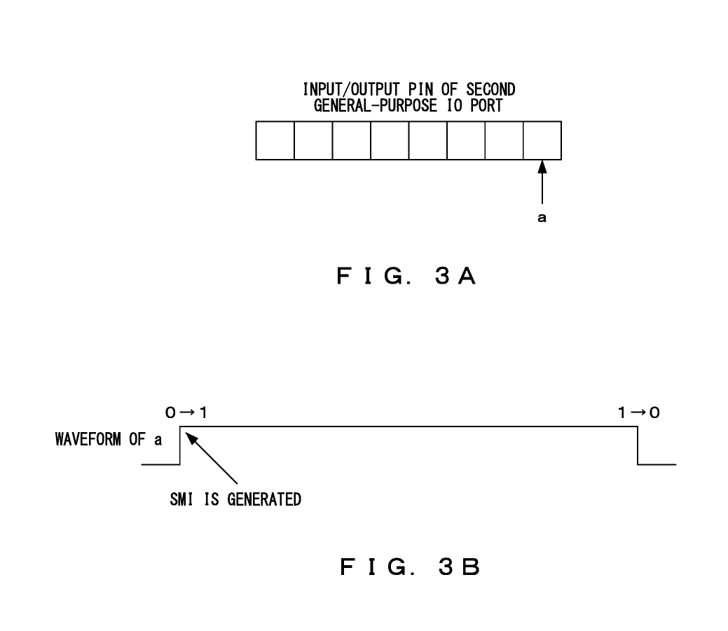

FIGS. 3A and 3B illustrate examples of an input/output pin and a waveform when an SMI is generated. As illustrated in the example of FIG. 3, one of the input/output pins of the second general-purpose IO port 27 is assigned to an SMI. As illustrated in FIG. 3B, when issuing an SMI, the second CPU 21 changes an input/output pin of “a” from “0” to “1” (the change maybe from “1” to “0”).

For example, an SMI can be generated by changing a voltage of a signal line of an input/output pin from Low level to High level (or from High level to Low level). A signal from an input/output pin of the second general-purpose IO port 27 is input into the first CPU 2 through the interface 5. This permits the first CPU 2 to recognize an issuance of an SMI. In FIG. 2, the first general-purpose IO port 26 and the second general-purpose IO port 27 are separated, but they may be one general-purpose IO port.

### <Firmware of Keyboard Controller>

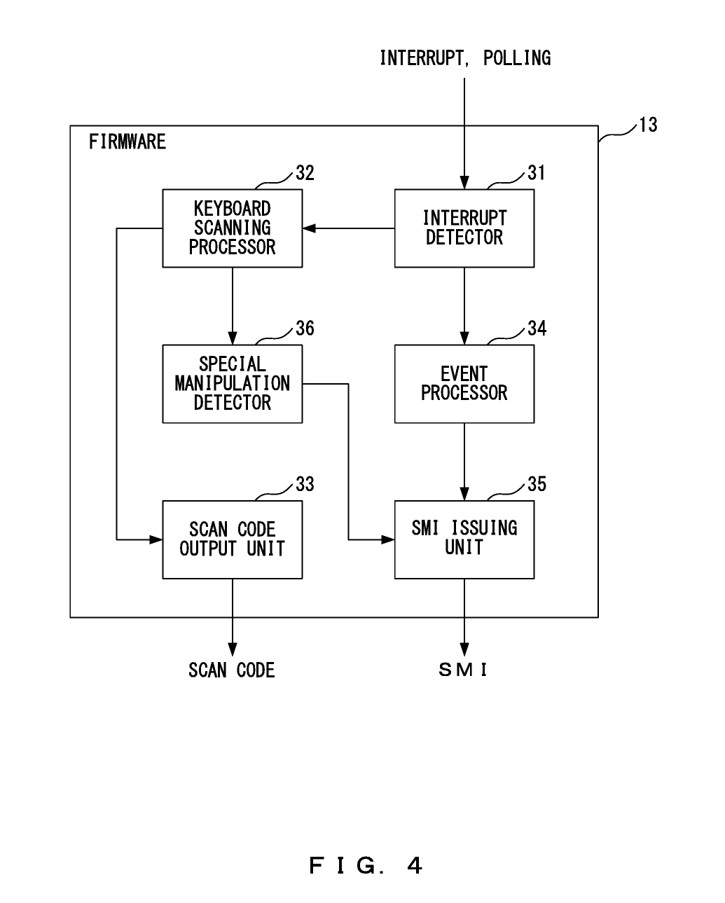

Next, the firmware 13 of the keyboard controller 7 is described. FIG. 4 is a block diagram that illustrates an example of a function of the firmware 13. The firmware 13 includes an interrupt detector 31, a keyboard scanning processor 32, a scan code output unit 33, an event processor 34, an SMI issuing unit 35, and a special manipulation detector 36. A function of each of the components of the firmware 13 may be performed by the second CPU 21.

The interrupt detector 31 detects an interrupt or a polling input from the keyboard 8. The keyboard scanning processor 32 scans the interrupt input from the keyboard 8. A scan code scanned by the keyboard scanning processor 32 is output from the scan code output unit 33.

The event processor 34 performs, for example, polling processing. The SMI issuing unit 35 issues an SMI when it determines that the SMI needs to be issued as a result of the event processor 34 performing, for example, the polling processing.

The special manipulation detector 36 obtains content scanned by the keyboard scanning processor 32 (manipulation information on the keyboard 8), and determines whether the scanned content is a special manipulation. As the special manipulation, there are a first special manipulation and a second special manipulation that are described later. When the special manipulation detector 36 detects the second special manipulation, the SMI issuing unit 35 issues an SMI.

### <Handler for SMI>

Next, a handler for an SMI is described. The SMI is an interrupt specific to the first CPU 2 and is a hardware-level interrupt that is not dependent on an OS. Thus, when the SMI is issued, the first CPU 2 performs interrupt processing of an SMI regardless of the state of the OS. The handler that performs the interrupt processing of an SMI is referred to as a system management mode (SMM) handler.

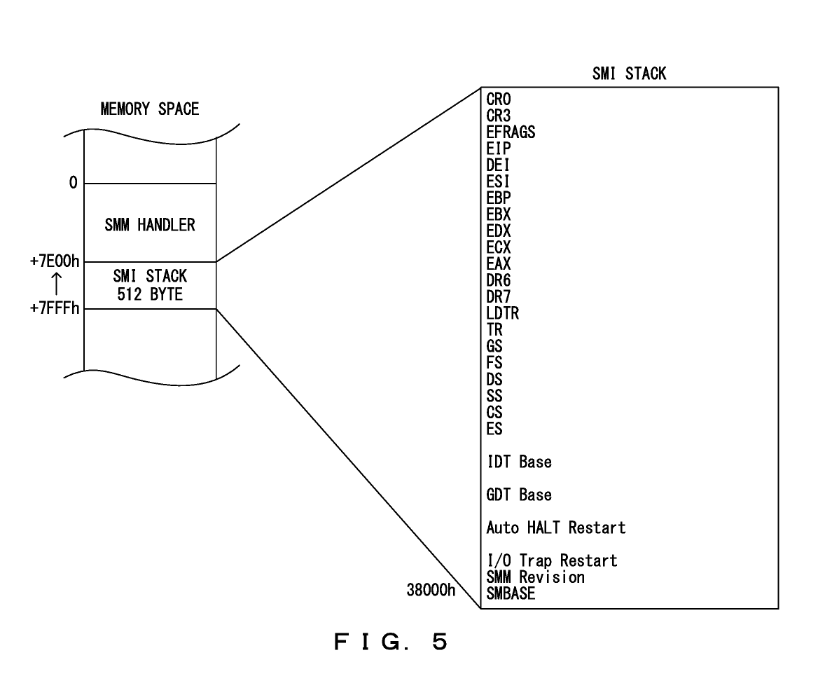

The SMM handler is stored in the memory 3 of the computer 1. FIG. 5 illustrates an example of the SMM handler. The SMM handler that performs processing of an SMI is stored in a prescribed area of the memory 3. The SMM handler and an SMI stack of FIG. 5 are the areas for an SMI.

The area of the SMM handler may be reserved by a basic input output system (BIOS) when the computer 1 is powered on. In the example of the memory space of the memory 3 illustrated in FIG. 5, 32 kbyte is reserved as an area for an SMI. The area for an SMI is not limited to 32 kbyte.

In the example of FIG. 5, an area of 512 byte is reserved from among the area for an SMI as the SMI stack. The area of the SMI stack is not limited to 512 byte. When the processing of an SMI is performed by the SMM handler, a state of a register of the first CPU 2 is stored in the SMI stack. This processing is performed in a hardware level of the first CPU 2.

The SMI stack of FIG. 5 is merely an example, and the state of the register stored in the SMI stack is not limited to the example illustrated in FIG. 5. When the state of the register of the first CPU 2 is stored in the SMI stack, a push is performed in turn in a direction from “+7FFFh” to “+7E00h”, and, as a result, the register state is stored.

When the processing of storing the register state is terminated, the first CPU 2 starts performing processing starting from a start address of the SMM handler. In the example of FIG. 5, “SMBASE” is a base address that is “38000h” in the example of FIG. 5. Accordingly, processing of the SMM handler is started.

When the processing of the SMM handler is terminated, the state of the register of the first CPU 2 stored in the SMI stack is restored. Then, the process returns from the processing of the SMM handler to the program that was formerly executed. As an example, the setting may be made such that an interrupt return (IRET) instruction is executed when the processing of the SMM handler is terminated. The IRET instruction is an instruction to transfer a control from interrupt processing to a former program.

In the example of FIG. 5, the base address of the SMI stack is “38000h”. This base address can be rewritten discretionally. Further, when an area (32 kbyte) specific to an SMI is reserved, the area specific to an SMI may be reserved on the basis of the base address. In this case, the base address can be rewritten discretionally, so any area in the memory 3 can be used as the area specific to an SMI.

The area specific to an SMI is reserved by the BIOS, and the SMM handler is executed by the first CPU 2. Thus, even when a failure occurs in the OS, the first CPU 2 automatically saves the state of the register to the SMI stack. Accordingly, even when a failure occurs in the OS, the state of the register of the first CPU 2 will not be lost.

### <Processing of Embodiment>

Next, processing of the embodiment is described. When any failure occurs in the computer 1 and a normal operation is not performed, a dump collection is preferably performed. Accordingly, failure restoration processing can be performed on the basis of the collected dump. The processing below can be realized even when no failures have occurred yet.

An operator who manipulates the computer 1 (hereinafter referred to as a user) is performing a prescribed manipulation using the computer 1. It is assumed that, at this point, there occurs some failure in the computer 1. When a dump collection is performed, the user performs the first special manipulation. The first special manipulation is an example of a first manipulation.

Manipulation information on which of the keys in the keyboard 8 has been depressed is input into the first general-purpose IO port 26 of the keyboard controller 7. Thus, the second CPU 21 determines whether the first special manipulation has been performed on the basis of the manipulation information on the keyboard 8 (Step S1).

The first special manipulation is distinguished from a usual manipulation. The first special manipulation is preset in the keyboard controller 7. For example, the first special manipulation may be preset in the special manipulation detector 36 of the firmware 13.

For example, a typematic can be applied to the first special manipulation. The typematic has a function that repeatedly outputs the same consecutive key codes when a prescribed key in the keyboard 8 is depressed repeatedly. Alternatively, a prescribed “ON” or “OFF” manipulation with respect to a prescribed key (for example, a Caps Lock key) in the keyboard 8 may be the first special manipulation.

When recognizing that the first special manipulation has been performed with respect to the keyboard 8 (YES in Step S1), the keyboard controller 7 sets the first flag 11 to be “ON” (Step S2). On the other hand, when the first special manipulation is not performed (NO in Step S1), the first flag 11 is not set to be “ON”.

In order to set the first flag 11 to be “ON”, for example, a command on the basis of the first special manipulation may be written into a prescribed address of the firmware 13 of the keyboard controller 7. This permits the keyboard controller 7 to set the first flag 11 to be “ON”.

When the first flag is set to be “ON”, the keyboard controller 7 recognizes that a manipulation that is not a usual manipulation has been performed with respect to the keyboard 8. In other words, the keyboard controller 7 enters a mode in which it detects a content of the special manipulation. Thus, in the embodiment, an SMI is not issued at this point. However, the SMI may be issued when the first special manipulation is performed.

When the first flag is set to be “ON”, the keyboard controller 7 determines whether the second special manipulation has been performed (Step S3). Like the first special manipulation, the second special manipulation is also different from a usual manipulation and is preset in the keyboard controller 7. The second special manipulation is an example of a second manipulation.

For example, the second special manipulation may be preset in the special manipulation detector 36 of the firmware 13. The keyboard controller 7 can recognize whether the second special manipulation has been performed on the basis of the manipulation information on the keyboard 8 that is input into the first general-purpose IO port 26.

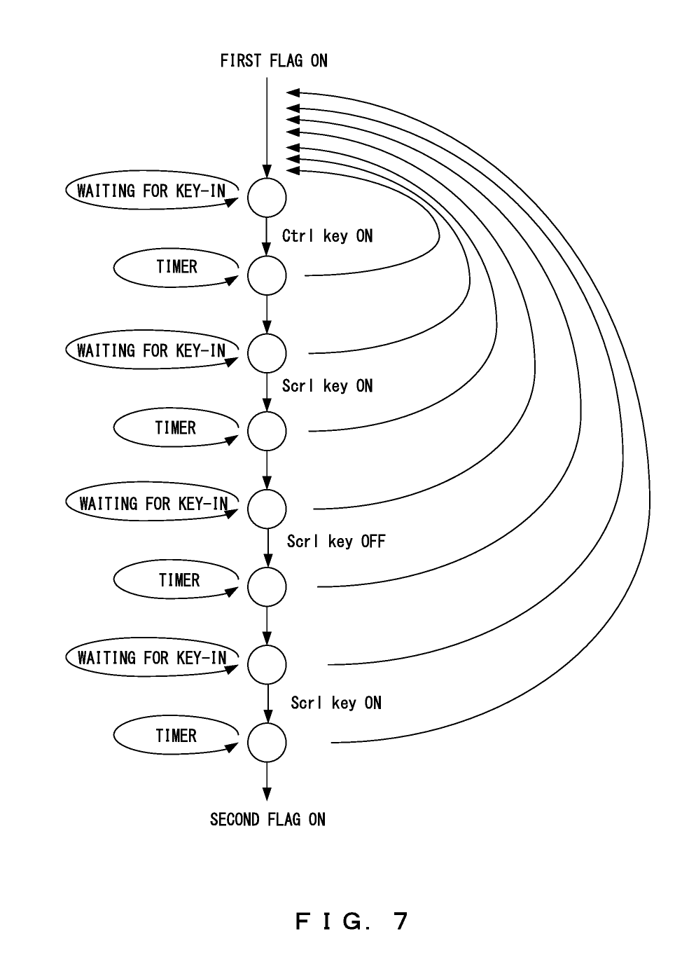

The second special manipulation may be any manipulation with respect to the keyboard 8. FIG. 7 illustrates an example of the second special manipulation. The second special manipulation illustrated in FIG. 7 as an example is a manipulation in which a “Ctrl” key is depressed once and a “Scrl” key is depressed twice.

As illustrated in FIG. 7, when the first flag is set to be “ON”, waiting for key-in is performed. Then, when the “Ctrl” key is turned on, the timer 25 starts measuring time. Then, the state transitions to a state of waiting for key-in. The timer 25 measures time until a preset prescribed time is reached.

When the “Scrl” key has been turned on before the time measured by the timer 25 reaches the prescribed time, the timer 25 resets the measured time and starts measuring time again. On the other hand, when the “Scrl” key has not been turned on before the time measured by the timer 25 reaches the prescribed time, the state transitions to the first state of waiting for key-in.

When the “Scrl” key has been turned on within the prescribed time, the state transitions to a next state. Then, when the “Scrl” key has been turned off before the time measured by the timer 25 reaches the prescribed time, the timer 25 resets the measured time and starts measuring time again. On the other hand, when the “Scrl” key has not been turned off before the time measured by the timer 25 reaches the prescribed time, the state transitions to the first state of waiting for key-in.

When the “Scrl” key has been turned off within the prescribed time, the state transitions to a next state. When the “Scrl” key has been turned on before the time measured by the timer 25 reaches the prescribed time, the keyboard controller 7 recognizes that the second special manipulation has been performed. In other words, the keyboard controller 7 recognizes that the “Ctrl” key has been depressed once and the “Scrl” key has been depressed twice. On the other hand, when the “Scrl” key has not been turned on before the time measured by the timer 25 reaches the prescribed time, the state transitions to the first state of waiting for key-in.

When recognizing that the second special manipulation has been performed, the keyboard controller 7 sets the second flag 12 to be “ON” (Step S4). In order to set the second flag 12 to be “ON”, for example, a command on the basis of the second special manipulation may be written into a prescribed address of the firmware 13 of the keyboard controller 7. This permits the keyboard controller 7 to set the second flag 12 to be “ON”.

When the second flag 12 is set to be “ON”, the second CPU 21 of the keyboard controller 7 issues an SMI (Step S5). The second CPU 21 controls the second general-purpose IO port 27 so as to output the SMI signal 27B. The SMI signal 27B is input into the first CPU 2 through the interface 5. The SMI signal 27B is input into the first CPU 2, which permits the first CPU 2 to detect the issuance of the SMI (Step S6).

The first CPU 2 reads the SMM handler from the memory 3 and executes the SMM handler. The SMM handler checks the second flag 12 of the keyboard controller 7 in order to confirm that the detected SMI is an interrupt from the keyboard controller (Step S7).

Accordingly, the first CPU 2 confirms a state of the second flag 12 of the keyboard controller 7. The SMM handler executed in the first CPU 2 confirms that the second flag 12 is “ON” so as to recognize that the keyboard controller 7 has issued the SMI.

An interrupt is input into the first CPU 2 not only from the keyboard controller 7 but also from other devices. Thus, there is a possibility that the first CPU 2 will input a plurality of interrupts at the same time. In this case, the first CPU 2 checks the second flag 12 of the first CPU 2 so as to recognize that the SMI is from the keyboard controller 7.

In other words, the second flag 12 is a flag that indicates an SMI issuance. On the other hand, the first flag 11 is a maskable flag. However, the first flag 11 may be non-maskable. Further, when an SMI is issued by the first special manipulation (when the second special manipulation is not performed), the two flags may be one flag.

When detecting the SMI issuance, the SMM handler saves the state of the register of the first CPU 2 to the SMI stack (Step S8). Accordingly, the state of the register of the first CPU 2 (a value) is stored in the memory 3 regardless of the state of the OS.

After the state of the register of the first CPU 2 is stored, the SMM handler performs NMI redirection processing (Step S9). The non-maskable interrupt (NMI) is a non-maskable interrupt that starts a dump collection function. The NMI is an OS-standard interrupt having a high priority. Thus, an SMI is not dependent on an OS, but the NMI is dependent on an OS. The NMI is an example of a second interrupt.

The NMI is an interrupt, so interrupt processing is performed by an interrupt handler, as is the case with an SMI. The interrupt handler for an NMI may hereinafter be referred to as an NMI handler. The NMI handler is stored in the memory 3 as a function of the OS.

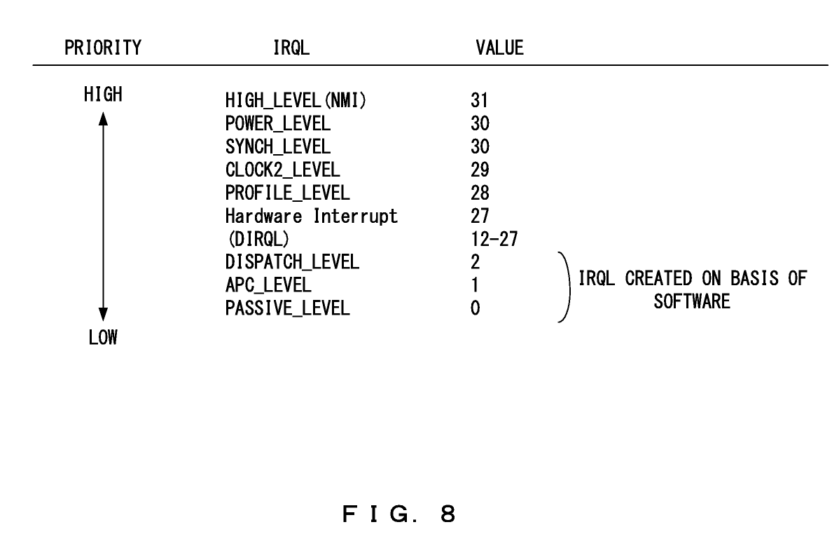

FIG. 8 illustrates an example of priority when interrupt processing is performed by an OS. As illustrated in the example of FIG. 8, from among the interrupts handled by an OS, an interrupt that has a highest priority is an NMI. An IRQ level (IRQL) represents a priority for each type of interrupt. “DISPATCH_LEVEL”, “APC_LEVEL”, and “PASSIVE_LEVEL” in FIG. 8 represent levels of a software interrupt of the OS. They are interrupts having a low priority.

On the other hand, the NMI belongs to an interrupt of a level that is higher than the level of a software interrupt of the OS. Thus, the NMI can interrupt at the point of need regardless of an operational state of the software interrupt of the OS.

Further, as illustrated in FIG. 8, there are a plurality of types of hardware interrupts, and priority is set for each of the hardware interrupts. In this regard, when there is a certain interrupt having a higher priority than the NMI and there occurs a problem with the certain interrupt, it is not possible to perform the NMI, and a dump collection is not performed. In the example of FIG. 8, the NMI has a highest-level priority. Thus, the NMI is able to interrupt at the point of need regardless of other hardware interrupts.

In this case, an SMI is not defined in the example of the interrupt processing illustrated in FIG. 8. In other words, the NMI is managed by the OS, but the SMI is not managed by the OS. Thus, no matter what state the OS is in, the SMI will not be affected. For this reason, the SMI can generate a trigger for a dump collection regardless of the state of the OS.

The SMI is a trigger for starting a dump collection, and dump collection processing is performed by the NMI that is managed by the OS. In other words, the NMI starts a dump collection with the SMI as a trigger for starting a dump collection.

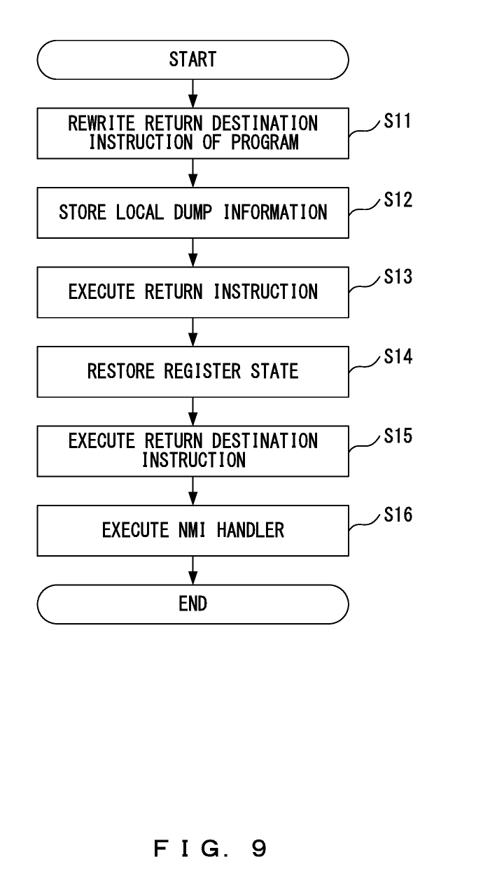

Accordingly, the first CPU 2 performs the NMI redirection processing when an SMI is issued. When the NMI redirection processing is performed, the control of interrupt processing is transferred to the NMI. The NMI redirection processing is described below with reference to FIG. 9.

When detecting an SMI issuance, the first CPU 2 recognizes the SMI as a trigger for a dump collection. Thus, the first CPU 2 stops processing the executing program and recognizes an instruction of the program when it is stopped. The instruction of the program when it is stopped is a return destination instruction. The first CPU 2 rewrites, with an instruction to start the NMI handler (for example, an INT2 instruction), the return destination instruction of the program (Step S11).

For example, the first CPU 2 may rewrite an address of the return destination instruction of the program with a start address of an instruction to start the NMI handler. Thereby, the address of an instruction executed by the first CPU 2 becomes a start address to start the NMI handler, which permits the first CPU 2 to start executing the NMI handler.

When a dump collection is performed, the program whose execution has been stopped is stored in a prescribed area of the memory 3. As an example, in the embodiment, it is assumed that the program is stored in the prescribed area of the memory 3 in the form of a stack. In this case, the first CPU 2 stores local dump information in a stack of the program (Step S12).

For example, the first CPU 2 may store SMI-stack information in the stack of the program as local dump information. This makes it possible to diagnose information temporarily by use of a register state stacked in the program even if the NMI handler is not able to collect the register state of the first CPU 2.

The SMM handler executed by the first CPU 2 executes a return instruction (an IRET instruction) (Step S13). This results in restoring the register state of the first CPU 2 stored in an SMM area of the memory 3 (Step S14). Thus, the state of the register of the first CPU 2 returns to a former state.

Next, the SMM handler executed in the first CPU 2 executes the return destination instruction (Step S15). In other words, the SMM handler executes processing of returning to the instruction when the program that was being formerly executed was stopped. At this point, the return destination instruction has been rewritten with the instruction to start the NMI handler in Step S11.

Thus, the first CPU 2 executes the return destination instruction, so as to start the NMI handler. Accordingly, processing by the NMI handler is performed (Step S16). This permits a transfer of control from an SMI to an NMI. In other words, interrupt processing is redirected from the SMM handler to the NMI handler.

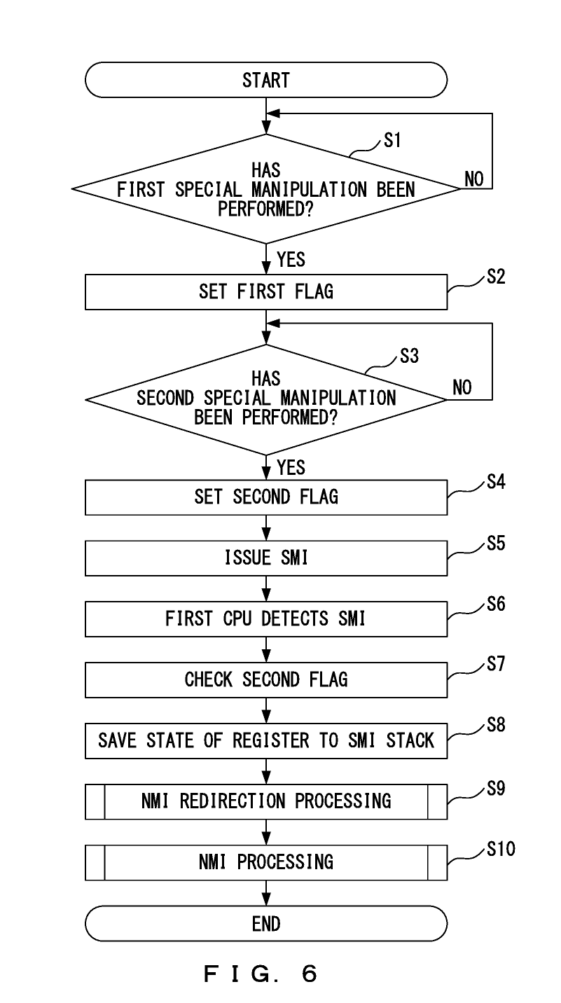

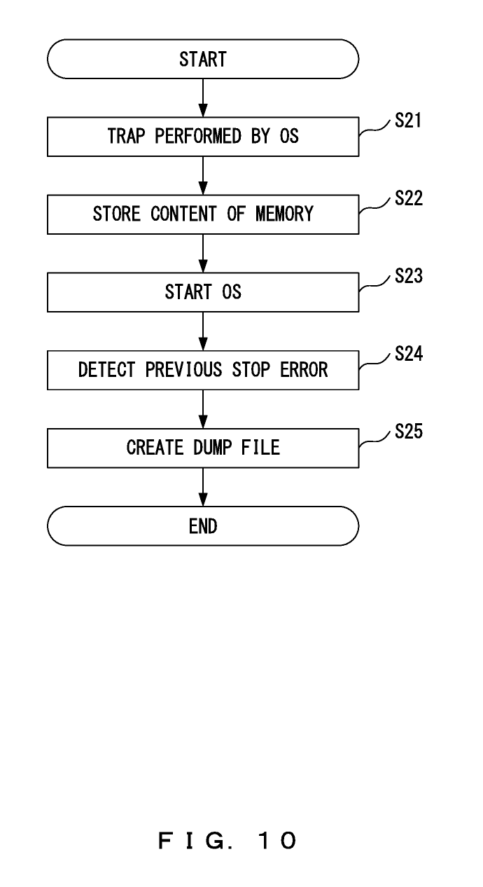

The NMI redirection processing of Step S9 of FIG. 6 has been described above. Next to the NMI redirection processing, the NMI handler of the first CPU 2 performs NMI processing (Step S10). The NMI processing is processing of actually performing a dump collection. FIG. 10 illustrates an example of the NMI processing.

When the NMI handler is started, a trap is performed by the OS (Step S21). When performing a trap, the OS stores, in the auxiliary storage 6, a content of the memory 3 needed for a dump collection (Step S22). In this case, a display indicating that a failure has occurred in the computer 1 may be presented on the display 4. For example, a blue screen may be displayed.

Then, the first CPU 2 starts the OS (Step S23). The first CPU 2 detects a previous stop error (Step S24) while starting the OS, and starts a program for performing a dump collection. The started program creates a dump file on the basis of the content stored in the memory 3 (Step S25). Accordingly, a dump collection is performed. The first CPU 2 stores the created dump file in the auxiliary storage 6.

The NMI processing illustrated in FIG. 10 as an example is processing for performing a dump collection. Thus, if a dump collection can be performed, it is not limited to the processing of FIG. 10. If a dump collection can be performed by performing NMI processing, a dump collection may be performed by a method other than that of FIG. 10. Further, the interrupt to which an SMI redirects is not limited to an NMI if it permits performing of a dump collection.

For example, from the example of FIG. 8, the interrupt to which an SMI redirects may be an interrupt defined by a hardware interrupt (DIRQL), not an NMI. The interrupt to which an SMI redirects may be any hardware interrupt if it permits a start of a dump collection. However, in order to override other hardware interrupts, the interrupt to which an SMI redirects is preferably an NMI that is defined by the OS and that has a highest priority.

Here, the processing of the embodiment is terminated. When a restoration from a failure that has occurred in the computer 1 is performed, a failure diagnosis is performed on the basis of a collected dump. A prescribed analysis tool may be used for performing a failure diagnosis.

The analysis tool may be stored in the auxiliary storage 6. For example, the setting may be made such that an analysis tool starts automatically upon the completion of a dump collection. Then, a failure restoration may be performed on the basis of a diagnosis result, so as to restore the computer 1 to a normal state.

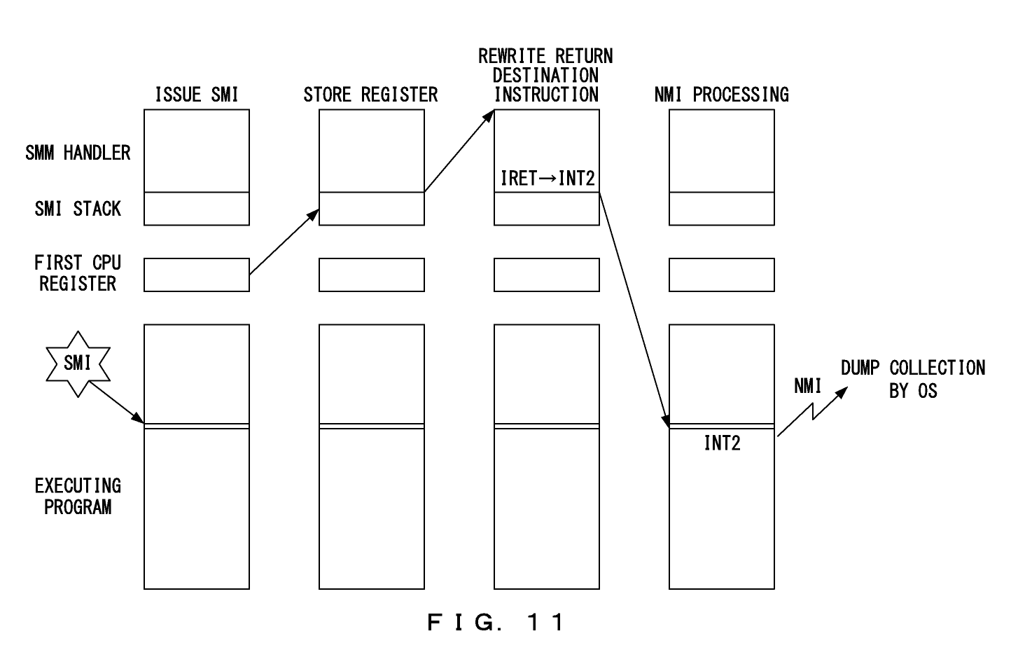

Next, a transition of the state of the memory 3 is described with reference to the example of FIG. 11. The executing program illustrated in FIG. 11 is a program which the first CPU 2 was executing before an SMI is issued.

When the first special manipulation and the second special manipulation are performed with respect to the keyboard 8, the second CPU 21 of the keyboard controller 7 issues an SMI. This stops the processing of the executing program. The address indicated by “SMI” in FIG. 11 refers to a stopped instruction.

Upon detection of the SMI, the first CPU 2 confirms whether a second flag is “ON”. When it is confirmed that the second flag is “ON”, the first CPU 2 saves the state of the register to the SMI stack of the memory 3. When the save of the state of the register has been completed, the first CPU 2 rewrites the return destination instruction. In the example of FIG. 11, the return destination instruction has been rewritten from “IRET” to “INT2”.

Upon a return from the SMI, the first CPU 2 executes the return destination instruction. At this point, the return destination instruction has been rewritten with “INT2”. “INT2” is an instruction that starts the NMI handler, so an NMI instruction is executed. The execution of the NMI instruction permits the OS to perform a dump collection. The collected dump is stored in the auxiliary storage 6.

As described above, an SMI (a first interrupt) that is an interrupt specific to a CPU is generated, and then a redirection is performed so as to redirect from processing of an SMI (such as processing of an SMM handler) to an NMI (a second interrupt) that starts a dump collection function. The SMI is an interrupt that is not managed by an OS, so the first CPU 2 can detect the SMI regardless of the state of the OS.

The SMI is a trigger for starting a dump collection, so even when the OS is not able to detect the trigger, the first CPU 2 is able to detect the trigger for starting a dump collection. Then, the redirection from the SMI to the NMI permits the NMI to perform a dump collection. Thus, even when the OS is not able to detect the trigger for a dump collection, a dump collection can be performed.

An SMI is issued when the first special manipulation and the second special manipulation are performed with respect to the keyboard 8. In the embodiment, the OS does not detect a failure, but an SMI is generated when a manipulation to issue an SMI is performed with respect to the keyboard 8. This permits performing of a dump collection.

Further, when an NMI is used as a trigger for starting a dump collection, there is a possibility that the trigger for starting a dump collection will not be detected, depending on the state of an OS, because the NMI is managed by the OS. On the other hand, an SMI is not managed by the OS and is an interrupt specific to a CPU, so the first CPU 2 is able to detect the trigger for starting a dump collection regardless of the state of the OS.

Furthermore, the NMI is managed by the OS, so the specification of a handler is dependent on that of the OS. On the other hand, the SMI is not managed by the OS, so it is possible to set the specification of a handler discretionally. Thus, a user can provide any function to an SMI, which permits an increased flexibility in dump collection processing.

Moreover, a handler for an SMI has an individual SMM stack, so a trace of a relay of the handler for an SMI will not be left in a stack of an OS, so redirection processing is hidden from the OS because the SMI redirects to the NMI. Thus, the processing of an SMI is not reflected in a collected dump.

The above-described analysis tool analyzes an occurrence factor of a failure on the basis of a collected dump. In this case, the processing of an SMI is not reflected in the collected dump, so a conventional analysis tool can be used.

Further, when an SMI that is not managed by the OS has been issued, the state of the register of the first CPU 2 is saved to the SMI stack of the memory 3. Thus, it is possible to reserve at least the state of the register of the first CPU 2 regardless of the state of the OS.

Furthermore, the computer 1 that performs the processing of the embodiment may be applied not only to a computer that has a plurality of CPUs but also to a computer that has one CPU. The embodiment may be applied to the computer 1 having a single CPU without a need for two CPUs, a bootstrap processor (BSP) and an application processor (AP).

In the embodiment, the example of issuing an SMI on the basis of the first special manipulation and the second special manipulation performed with respect to the keyboard 8 has been described, but any method may be used to issue an SMI. For example, a SMI may be issued by controlling the SMI issuing unit 35 according to a result of polling processing performed by the event processor 34 of FIG. 4.

As described above, even when a trigger for starting a dump collection is not recognized by an OS, it is possible to start a dump collection.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method for diagnosing an information processing device, comprising:
issuing a first interrupt that is an interrupt specific to a CPU;
transferring a control from processing of the first interrupt to a second interrupt that starts a dump collection function; and
starting a dump collection on the basis of the second interrupt.

2. The method for diagnosing an information processing device according to claim 1, wherein
the second interrupt has a higher priority than a software interrupt from among a plurality of interrupts defined by an operating system.

3. The method for diagnosing an information processing device according to claim 2, wherein
the second interrupt has a highest priority from among the plurality of interrupts defined by the operating system.

4. The method for diagnosing an information processing device according to claim 1, comprising
rewriting a return destination instruction upon a return from the processing of the first interrupt from an instruction of a program whose execution was stopped by the first interrupt to an instruction to start the second interrupt.

5. The method for diagnosing an information processing device according to claim 1, comprising
generating the first interrupt when a second manipulation that is different from a usual manipulation is performed with respect to a keyboard after a first manipulation that is different from the usual manipulation is performed.

6. The method for diagnosing an information processing device according to claim 5, comprising:
turning on a first flag of a keyboard controller that controls the keyboard when the first manipulation is performed;
turning on a second flag of the keyboard controller when the second manipulation is performed; and
generating the second interrupt when the CPU confirms that the second flag is ON.

7. The method for diagnosing an information processing device according to claim 1, comprising
saving a state of a register of the CPU to a memory when the CPU detects the first interrupt.

8. The method for diagnosing an information processing device according to claim 1, wherein
the first interrupt is a system management interrupt, and
the second interrupt is a non-maskable interrupt.

9. The method for diagnosing an information processing device according to claim 4, comprising
rewriting an address of the return destination instruction with a start address of the instruction to start the second interrupt.

10. A non-transitory computer-readable recording medium having stored therein an information-processing-device diagnosing program for causing a CPU to execute a process comprising:
issuing a first interrupt that is an interrupt specific to the CPU;
transferring a control from processing of the first interrupt to a second interrupt that starts a dump collection function; and
starting a dump collection on the basis of the second interrupt.

11. An information processing device comprising a CPU configured to execute a process including:
inputting a first interrupt that is an interrupt specific to the CPU;
transferring a control from processing of the first interrupt to a second interrupt that starts a dump collection function; and
starting a dump collection on the basis of the second interrupt.
